(19) United States
(12) Patent Application Publication
(10) Pub. No.: US 2007/0067790 A1
(43) Pub. Date: Mar. 22, 2007

(54) Turntable as well as a device comprising such a turntable

(75) Inventors: Jacobus Cornelis Gerardus Van Der Sanden, Eindhoven (NL); Johannes Martinus Maria Hensing, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,016

(22) PCT Filed: Oct. 18, 2004
(86) PCT No.: PCT/IB04/52120

§ 371 Date: Apr. 24, 2006

(30) Foreign Application Priority Data
Oct. 28, 2003 (EP) 03103986.0

(51) Int. Cl. G11B 17/028

(52) U.S. Cl. 720/704

(57) ABSTRACT

A turntable (1) and a device comprising a turntable suitable for disc-shaped information carriers having a central opening. The turntable comprises a centering element (8) comprising a cone-shaped centering portion (12), which centering element is rotatable about an axis of rotation and is movable in axial direction against a spring force. The centering element further comprises a substantially cylindrical portion (11) which adjoins the end of the cone-shaped centering portion positioned nearest the central axis.

The invention relates to a turntable suitable for disc-shaped information carriers having a central opening, which turntable comprises a centering element comprising a cone-shaped centering portion, which centering element is rotatable about an axis of rotation and is movable in axial direction against spring force.

The invention further relates to a device for carrying out operations on a disc-shaped information carrier having a central opening.

With such a turntable and a device for carrying out operations on a disc-shaped information carrier, which are known from international patent application WO 02/080165, a disc-shaped information carrier having a central opening is positioned around a cone-shaped centering portion of a centering element, after which pressure means press the information carrier into contact with a support surrounding the centering element. Subsequently, the centering element and the support, the disc-shaped information carrier present thereon, and the pressure means are jointly rotated, during which rotation information present on the information carrier is read from said information carrier and/or information is written onto said information carrier.

When the information carrier is being pressed into contact with the support surrounding the centering element, the centering element is moved in axial direction against the spring force of a spring, as a result of which the central opening of the information carrier is centered around the cone-shaped centering portion. An imbalance in the disc-shaped information carrier leads to imbalance forces in a direction perpendicular to the central axis upon rotation of the turntable. Said imbalance forces acting on the information carrier lead to forces being exerted on the centering element by the information carrier. Said forces act on the cone-shaped centering portion, causing forces to be exerted on the cone-shaped centering portion in a direction away from the pressure means, parallel to the central axis. As soon as the forces being exerted on the cone-shaped centering portion as a result of the imbalance forces become greater than the spring force acting on the cone-shaped centering portion, the cone-shaped centering portion will be pressed in a direction away from the driving means. As a result, the central opening will be positioned around a part of the cone-shaped centering portion that has a smaller diameter than the opening, causing the imbalance of the information carrier and the resulting imbalance forces to become even greater. As soon as the centering element cannot move in axial direction any further and the imbalance forces that occur become greater than the forces exerted by the pressure means, the pressure means will be moved out of contact with the information carrier and the information carrier will be flung off the centering element, which is obviously undesirable.

It is an object of the present invention to provide a turntable wherein the imbalance forces are absorbed in a simple manner, thus preventing a disc-shaped information carrier from becoming detached from the centering element.

This objective is achieved with the turntable according to the invention in that the centering element further comprises a substantially cylindrical portion which adjoins the end of the cone-shaped portion positioned nearest the central axis.

When imbalance forces occur, causing the central element to be moved in axial direction against spring force, the central opening will extend around the substantially cylindrical portion of the centering element once the centering element has moved a certain distance. The imbalance forces acting on the substantially cylindrical portion do not result in any significant force in a direction parallel to the central axis, as a result of which the centering element will not be moved in axial direction any further, so that the information carrier is prevented from being flung off the centering element in a relatively simple manner.

The diameter of the substantially cylindrical portion corresponds to the diameter of the end of the cone-shaped portion that is positioned nearest the central axis. Said diameter will be smaller than the diameter of the central opening in the information carrier, as a consequence of which the information carrier will not be properly centered at that point. Additional measures may have to be taken in that case, such as reducing the speed at which the information is rotated about the central axis, to correctly center the information carrier again by means of the pressure means and the centering element

One embodiment of the turntable according to the invention is characterized in that the centering element comprises a cone-shaped pre-centering portion, whose end located furthest away from the central axis adjoins the substantially cylindrical portion at a side remote from the centering portion.

The disc-shaped information carrier may be placed on the centering element in a relatively imprecise manner by means of the cone-shaped pre-centering portion, after which the central opening is successively moved over the pre-centering portion and over the substantially cylindrical portion into a position around the cone-shaped centering portion, where it is precisely positioned with respect to the centering element.

Another embodiment of the turntable according to the invention is characterized in that a wall of the cylindrical portion extends at an angle of 0 to 5° with respect to the central axis.

Although the wall of the cylindrical portion preferably extends parallel to the central axis, it is also possible to position the wall of the cylindrical portion at a small angle of approximately maximally 5°, whereby the occurrence of relatively great forces in a direction parallel to the central axis, which cause the centering element to move in axial direction, is further prevented in a relatively simple manner.

Yet another embodiment of the turntable according to the invention is characterized in that the angle which a wall of the centering portion encloses with the central axis is smaller than the angle which a wall of the pre-centering portion encloses with the central axis.

In this way an information carrier is pre-centered relatively quickly by means of the pre-centering portion, whilst subsequently the information carrier is centered on the centering portion with relatively great precision.

The invention further relates to a device comprising a turntable according to the invention. This device is defined in the claims 5 and 6.

Such a device makes it possible to center disc-shaped information carriers in a relatively precise manner, whilst the information carrier will remain reliably positioned around the centering element, even when relatively great imbalance forces occur.

The invention will be explained by way of example in more detail hereinafter with reference to the drawing, in which:

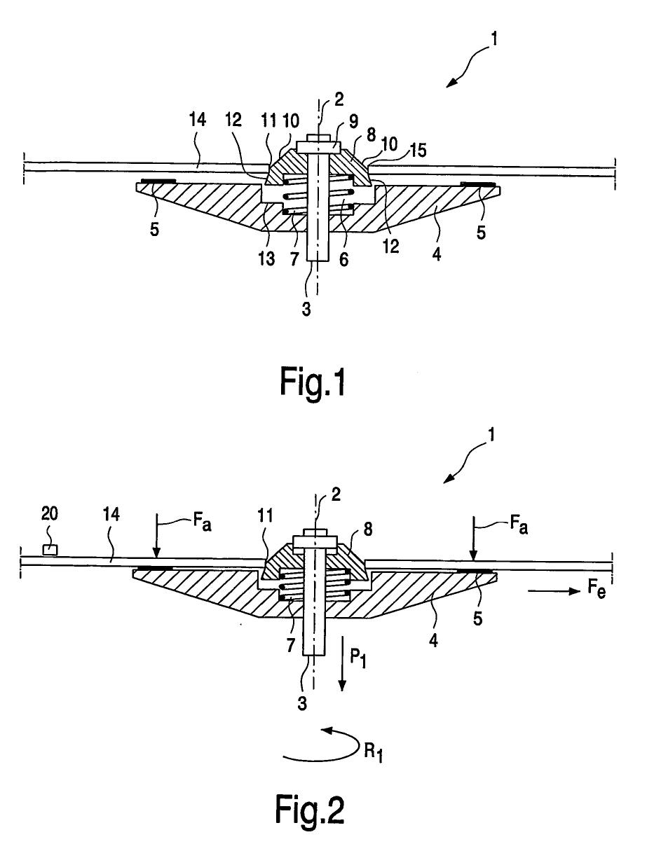

FIG. 1 is a schematic cross-sectional view of a turntable according to the invention;

FIG. 2 schematically shows the device according to the invention, in which an information carrier is pressed against a support;

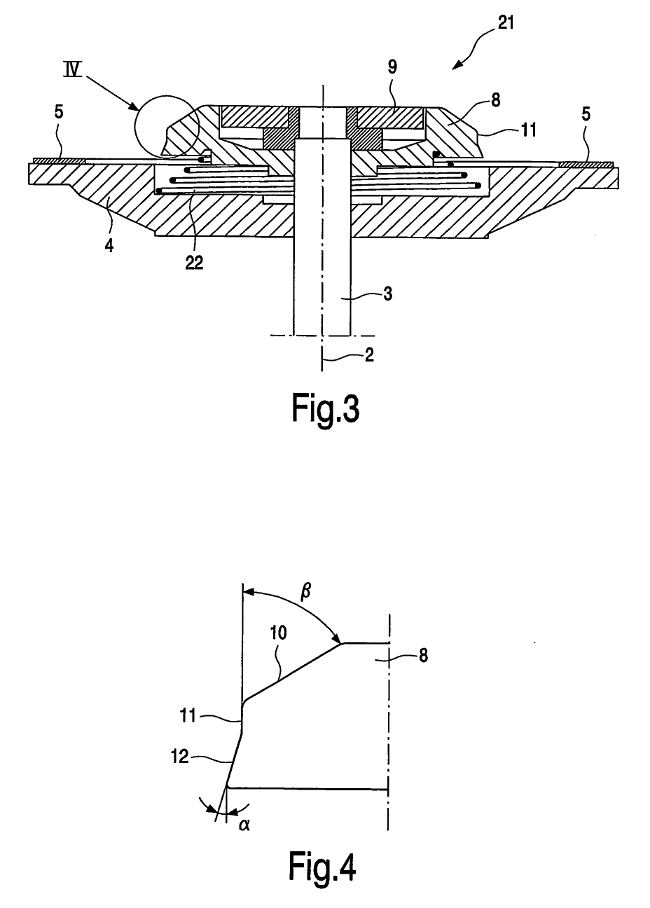

FIG. 3 schematically shows another embodiment of a turntable according to the invention; and

FIG. 4 shows a detail IV of the turntable of FIG. 3.

Like parts are indicated by the same numerals in the Figures.

FIG. 1 shows a turntable 1 according to the invention which comprises a shaft 3 that is rotated about a central axis 2. The shaft 3 extends through a support 4 which is rigidly connected to the shaft 3. Said support 4 comprises an annular strip 5 of a friction-increasing material. The support 4 is provided with a chamber-like recess 6 which accommodates a spring 7. Said spring 7 is biased against a centering element 8 which is capable of sliding over the shaft 3. The centering element 8 is retained on the shaft at a side remote from the spring 7 by means of a ring 9 connected to the shaft 3. The centering element 8 comprises a cone-shaped pre-centering portion 10, an adjoining, substantially cylindrical portion 11 (shown more clearly in FIG. 4), and a cone-shaped centering portion 12 adjoining said cylindrical portion 11. The chamber 6 of the support 4 comprises an annular bearing surface 13 for the centering element 8.

The turntable 1 may form part of a device suitable for carrying out operations on a disc-shaped information carrier. Such a device, particularly a device for reading information from and/or writing information onto an information carrier, particularly an optical disc, further comprises an optical head 20, see FIG. 2. The operation of the optical head 20 is generally known. The operation of the turntable 1 is as follows. A disc-shaped information carrier 14 having a central opening 15 is laid on the cone-shaped pre-centering portion 10, whereupon the disc-shaped information carrier 14 first slides over said pre-centering portion 10 and subsequently over the substantially cylindrical portion 15, after which the edge of the opening 15 comes into contact with the cone-shaped centering portion 12 in a particular position. In the position where the edge of the opening 15 abuts against a cone-shaped centering portion 10 substantially all around, the diameter of the opening 15 corresponds to the diameter of the cone-shaped centering portion 12. Said diameter of the opening 15 ranges between 15 mm and 15.15 mm.

Following that, pressure forces Fa cause the information carrier 14 to move jointly with the centering element 8 in the direction indicated by the arrow P1, against the spring force of the spring 7, until the information carrier 14 abuts against the strip 5 of friction-increasing material. Then the shaft 3 is driven in the direction indicated by the arrow R1, causing the shaft 3 to be jointly rotated with the support 4 and the information carrier 14 present thereon, which has been centered by the centering element 8.

During said rotation, imbalance forces (indicated by the arrow Fe in FIG. 2) may occur in a direction perpendicular to the central axis 2. Said imbalance forces may be caused, for example, by an imprecisely centered opening in the information carrier 14, by local mass differences introduced in the information carrier during the manufacturing process, by wear, etc. The imbalance forces Fe acting on the information carrier exert a force on the centering element 8, as a result of which the centering element 8 is pressed in a direction indicated by the arrow P1 against the spring force of the spring 7. Said downward force results from the fact that the wall of the cone-shaped centering portion encloses a relatively great angle of e.g. 15° with the central axis 2. After the element 8 has been moved a particular distance in the direction indicated by the arrow P1, the edge of the opening 15 will partially abut against the substantially cylindrical portion 11 and partially be spaced therefrom, because the diameter of the opening 15 is greater than the diameter of the cylindrical portion 11. In the position where the edge of the opening 15 abuts against the substantially cylindrical portion 11, the imbalance forces Fe exert hardly any downward forces, if at all, on the centering element in the direction indicated by the arrow P1, as a result of which the element 8 is prevented from moving any further in the direction indicated by the arrow P1.

If the device can still read from and/or write onto the disc-shaped information carrier 14 in this position, additional measures need not be taken. If reading or writing is no longer possible with sufficient precision, however, the speed at which the shaft 3, and thus the information carrier 14, is rotated in the direction indicated by the arrow R1 must be reduced, as a result of which the imbalance forces Fe will decrease and the centering element 8 will be moved in the opposite direction of the arrow P1 under the influence of the spring force 7, causing the cone-shaped centering portion 12 to be pressed into the opening 15 and the information carrier 14 to be centered around the centering element 8.

FIG. 3 shows a second embodiment of a turntable 21 according to the invention, which corresponds in large measure to the turntable 1 of FIG. 1. The turntable 21 comprises a cone-shaped spring 22 by means of which the centering element 8 is pressed away from a support 4 and into contact with an annular stop 9 connected to a shaft 2. The cylindrical portion 11 is clearly shown in FIG. 3.

FIG. 4 is a larger-scale view of a detail IV of the turntable 21 shown in FIG. 3. As FIG. 4 clearly shows, a wall of the cone-shaped centering portion 12 encloses an angle α with the central axis 2, a wall of the cylindrical portion 11 encloses an angle of 0° with the central axis 2, and a wall of the cone-shaped pre-centering portion 10 encloses an angle β with the central axis 2. As is clearly shown in FIG. 4, the angle α is smaller than the angle β. Preferably, the angle α is of the order of 15°, whilst the angle β is preferably of the order of 600. Although the angle that a wall of the cylindrical portion 11 encloses with the central axis 2 preferably equals 0, it is also possible to have said wall enclose a small angle, e.g. of maximally 5°, with the central axis 2, whereby, depending on the imbalance forces Fe to be maximally expected, the centering element 8 is further prevented from being moved relatively far towards the support 4 against the spring force of the spring 22 in a simple manner. Preferably, the centering element 8 is made of a metal or of a relatively high-quality plastic because of the shape stability thereof.

Preferably, a minimum height is used for the cylindrical portion 11 in axial direction, for example a height of about 0.2 mm.

1. A turntable suitable for disc-shaped information carriers having a central opening, which turntable comprises a centering element comprising a cone-shaped centering portion, which centering element is rotatable about an axis of rotation and is movable in axial direction against spring force, characterized in that the centering element further comprises a substantially cylindrical portion which adjoins the end of the cone-shaped portion positioned nearest the central axis.

2. A turntable according to claim 1, characterized in that the centering element comprises a cone-shaped pre-centering portion, whose end located furthest away from the central axis adjoins the substantially cylindrical portion at a side remote from the centering portion.

3. A turntable according to claim one, characterized in that a wall of the cylindrical portion extends at an angle of 0 to 5° with respect to the central axis.

4. A turntable according to claim 1, characterized in that the angle which a wall of the centering portion encloses with the central axis is smaller than the angle which a wall of the pre-centering portion encloses with the central axis.

5. A device suitable for carrying out operations on a disc-shaped information carrier having a central opening, wherein the device comprises the turntable according to claim 1 for rotating the disc-shaped information carrier.

6. A device for reading information from and/or writing information onto an optical information carrier having a central opening, which device comprises the turntable according to claim 1 and an optical head.
